(19) United States
(12) Patent Application Publication
(10) Pub. No.: US 2014/0016574 A1
(43) Pub. Date: Jan. 16, 2014

(54) METHOD OF TRANSCEIVING FOR DEVICE TO DEVICE COMMUNICATION

(71) Applicant: Electronics & Telecommunications Research Institute, (US)

(72) Inventors: Bang Won SEO, Daejeon (KR); Young Jo KO, Daejeon (KR); Tae Gyun NOH, Daejeon (KR); Jae Young AHN, Daejeon (KR)

(73) Assignee: Electronics & Telecommunications Research Institute, Daejeon (KR)

(21) Appl. No.: 13/873,975

(22) Filed: Apr. 30, 2013

(30) Foreign Application Priority Data
Apr. 30, 2012 (KR) 10-2012-0045195
Aug. 3, 2012 (KR) 10-2012-0085066
Apr. 29, 2013 (KR) 10-2013-0047560

(51) Int. Cl. H04W 76/02

(52) U.S. Cl. CPC H04W 76/023
USPC 370/329; 370/328

(57) ABSTRACT

A method of transmitting and receiving a specific reference signal in single point transmission and multi-point transmission is disclosed. The specific reference signal transmission method includes determining specific reference signal transmission resources for at least one terminal targeted for transmission, and transmitting the specific reference signal using the determined transmission resources and notifying of information for a layer used by the terminal. The specific reference signal transmission method includes determining specific reference signal reception resources, receiving the information for the layer used by the terminal from a serving cell base station, and receiving the specific reference signal using the information for determined transmission resources and the layer. Therefore, the terminal can recognize a position and a sequence of the specific reference signal. Particularly, in the case of multi-user MIMO and cooperative scheduling, signal interference can be suppressed or removed using the specific reference signal of another terminal.

### CLAIM FOR PRIORITY

This application claims priorities to Korean Patent Application Nos. 10-2012-0045195 filed on Apr. 30, 2012, 10-2012-0085066 filed on Aug. 3, 2012 and 10-2013-0047560 filed on Apr. 29, 2013 in the Korean Intellectual Property Office (KIPO), the entire contents of which are hereby incorporated by references.

### BACKGROUND

1. Technical Field

Example embodiments of the present invention relate to device-to-device communication, and more specifically, measurement of link channel state information for device-to-device communication, a method of modulating and demodulating a data channel, a method of mapping resources of the data channel, and design of a control channel.

2. Related Art

Device-to-device communication (hereinafter also referred to as D2D communication) means a communication scheme of performing direct data transmission and reception between two adjacent terminals, not via a base station. In other words, two terminals perform communication as a data source and a data destination, respectively.

For example, direct communication between terminals may be used for a local media server which provides a large amount of data (e.g., a program of a rock concert or information for a performer) to visitors who participate in the rock concert or may be used for the purpose of offloading to share a load of a base station.

In this case, each terminal connects to a serving cell to perform a telephone communication, the Internet access or the like using a conventional cellular link, but may directly transmit or receive a large amount of data described above from a local media server, which operates as a partner terminal of D2D communication, using a D2D scheme. Meanwhile, the D2D link may be not only established between terminals having the same cell as a serving cell, but also established between terminals having different cells as serving cells.

In such direct connection communication between terminals, a cellular network-based D2D communication scheme is a scheme in which a terminal which desires to communicate with another terminal requests a center node (a base station in a cellular network) performing control to establish a link, and the central node allocates radio resources for direct communication between the two terminals when the partner terminal is adjacent to the terminal, such that the direct communication between terminals is performed.

However, details of the cellular network-based D2D communication scheme, such as measurement of link channel state information, a method of modulating and demodulating a data channel, a method of mapping resources of the data channel, and a design of a control channel for device-to-device communication have not yet been determined.

### SUMMARY

Accordingly, example embodiments of the present invention are provided to substantially obviate one or more problems due to limitations and disadvantages of the related art.

Example embodiments of the present invention provide a method of determining a time point of transmission of data or control information for device-to-device communication, a method of modulating and demodulating a data channel for device-to-device communication, and a method of operating a SRS for measurement of channel state information of a device-to-device communication link.

Other example embodiments of the present invention provide a method of mapping resources of a data channel for device-to-device communication, an interference measurement method for interference management of a device-to-device communication link, and a design of a control channel for device-to-device communication.

In some example embodiments, there is provided a method of operating a terminal that receives data or control information from a partner terminal through direct communication between terminals using a subframe for D2D communication among subframes, the subframes being classified into a subframe for cellular communication and the subframe for D2D communication, wherein a D2D communication method includes: receiving state information of the partner terminal from a base station; and determining whether the data or the control information is received from the partner terminal in at least some symbols of the subframe for D2D communication based on the state information.

Here, the subframe for D2D communication may be arranged before or after the subframe for cellular communication. In this case, when the subframe for D2D communication is arranged after the subframe for cellular communication, the data or control information may not be received from the partner terminal in at least some front symbols of the subframe for D2D communication. In this case, when the subframe for D2D communication is arranged before the subframe for cellular communication, the data or control information may not be received from the partner terminal in at least some rear symbols of the subframe for D2D communication.

Here, the state information of the partner terminal may include at least some of UE-specific SRS subframe position information, PM-SRS transmission and reception subframe information, and CSI-SRS transmission and the reception subframe information.

In other example embodiments, there is provided a method of operating a terminal that receives data or control information from a partner terminal through direct communication between terminals using a subframe for D2D communication among subframes, the subframes being classified into a subframe for cellular communication and the subframe for D2D communication, wherein a D2D communication method includes: receiving information indicating whether at least some symbols of the subframe for D2D communication are used from a base station; and determining whether the data or the control information is received from the partner terminal in at least some symbols of the subframe for D2D communication based on the information indicating whether at least some symbols of the subframe for D2D communication are used.

Here, the information indicating whether at least some symbols of the subframe for D2D communication are used may be received as downlink control information (DCI) from the base station, and may include 1 or 2 bits.

In still other example embodiments, a method of transmitting control information in a terminal performing device-to-device communication includes: mapping a DM-RS (Demodulation RS) to subframe resources in which device-to-device communication (D2D) data is transmitted; mapping the control information to the subframe resources; mapping the device-to-device communication data to resources other than the resources to which the DM-RS and the control information are mapped among the subframe resources; and transmitting the subframe to a partner terminal of device-to-device communication.

Here, the control information may be preferentially mapped to a symbol adjacent to a symbol to which the DM-RS is mapped in the subframe resources.

Here, the control information may not be mapped to a first symbol of a first slot of the subframe resources and a last symbol of a second slot of the subframe resources.

Here, the control information may include at least one of new data indicator (NDI) information and ACK/NACK information.

Here, the new data indicator and the ACK/NACK information are subjected to separate coding or joint coding and mapped to the subframe resources.

Here, when the new data indicator and the ACK/NACK information are subjected to separate coding, at least one of the new data indicator and the ACK/NACK information may be mapped from an edge frequency band in the subframe resources. Alternatively, when the new data indicator and the ACK/NACK information are subjected to joint coding, the control information may be mapped from an edge frequency band in the subframe resources.

Here, the device-to-device communication data may not be mapped to a first symbol of a first slot of the subframe resources and a last symbol of a second slot of the subframe resources.

Cellular network-based device-to-device communication in which cellular mobile communication and a device-to-device communication scheme are combined is expected to spread in future.

As described above, example embodiments of the present invention provide a variety of details for cellular network-based device-to-device communication, such as a method of determining a time point of transmission of data or control information for device-to-device communication, a method of modulating and demodulating a data channel, a method of operating a SRS for measurement of channel state information, a method of mapping resources of a data channel, an interference measurement method for interference management of a device-to-device communication link, and a design of a control channel.

Example embodiments of the present invention provide cellular network-based device-to-device communication methods optimized for a 3GPP LTE system, and the technology of the present invention may be applied to a variety of cellular mobile communication systems as well as the 3 GPP LTE system.

### BRIEF DESCRIPTION OF DRAWINGS

Example embodiments of the present invention will become more apparent by describing in detail example embodiments of the present invention with reference to the accompanying drawings, in which:

FIGS. 1 and 2 are diagrams illustrating subframe structures used for a terminal to transmit a data channel to a base station in cellular communication;

FIG. 3 is a conceptual diagram illustrating a structure of a series of subframes in direct communication between terminals according to an example embodiment of the present invention;

FIG. 4 is a table showing whether transmission/reception for a first symbol of a subframe for D2D communication is possible according to a state of a terminal;

FIG. 5 is a table showing whether transmission/reception for a first symbol of a subframe for D2D communication is possible according to a state of a terminal;

FIG. 6 is a table showing whether transmission/reception for a last symbol of a subframe for D2D communication is possible according to a state of a terminal;

FIG. 7 is a table showing whether transmission/reception for a second symbol from an end of a subframe for D2D communication is possible according to a state of a terminal;

FIG. 8 is a table showing states of a terminal in which a first symbol of a subframe for D2D communication is available;

FIG. 9 is a table showing states of a terminal in which a last symbol of a subframe for D2D communication is available;

FIG. 10 is another table showing states of a terminal in which a first symbol of a subframe for D2D communication is available;

FIG. 11 is another table showing states of a terminal in which a last symbol of a subframe for D2D communication is available;

FIG. 12 is a conceptual diagram illustrating a concept of D2D reception synchronization estimation using a PM-SRS;

FIG. 13 is a conceptual diagram illustrating an example of a design of a D-PUCCH having a normal format;

FIG. 14 is a conceptual diagram illustrating an example of a design of a D-PUCCH having a shortened format;

FIG. 15 is a conceptual diagram illustrating another example of a design of a D-PUCCH having a normal format;

FIG. 16 is a conceptual diagram illustrating another example of a design of a D-PUCCH having a shortened format;

FIG. 17 is a conceptual diagram illustrating a transmission position of NDI;

FIG. 18 is a conceptual diagram illustrating an application example of NDI and A/N mapping method 1;

FIG. 19 is a conceptual diagram illustrating another application example of NDI and A/N mapping method 1;

FIG. 20 is a conceptual diagram illustrating an application example of NDI and A/N mapping method 2;

FIG. 21 is a conceptual diagram illustrating another application example of NDI and A/N mapping method 2;

FIG. 22 is a conceptual diagram illustrating an application example of NDI and A/N mapping method 3;

FIG. 23 is a conceptual diagram illustrating another application example of NDI and A/N mapping method 3;

FIG. 24 is a conceptual diagram illustrating an application example of NDI and A/N mapping method 4; and

FIG. 25 is a conceptual diagram illustrating another application example of NDI and A/N mapping method 4.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A “terminal” used in this disclosure may refer to user equipment (UE), a mobile station (MS), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, etc. Various examples of the terminal may include a cellular phone, a smartphone having a wireless communication function, a personal digital assistant (PDA) having a wireless communication function, a wireless modem, a portable computer having a wireless communication function, a photographing device such as a digital cameras having a wireless communication function, a gaming device having a wireless communication function, a music storage and reproduction home appliance have a wireless communication function, an Internet home appliance capable of wireless Internet access and browsing, and a portable unit or a terminal having a combination of such functions.

A “cell” or a “base station” used in this disclosure generally refers to a fixed or mobile point that communicates with a terminal and may be a term for collectively referring to a base station, node-B, eNode-B, a BTS (base transceiver system), an access point, a transmit point, a receive point, an RRH (Remote Radio Head), an RRE (Remote Radio Element), an RRU (Remote Radio Unit), a relay, a femto-cell, etc.

A normal cellular communication method by which two terminals (a first terminal and a second terminal) transmit or receive data or control information in a cellular mobile communication environment is performed via a base station.

In other words, when the first terminal has data or control information to be transmitted to the second terminal, the first terminal transmits the data or the control information to a base station (a first base station) that the first terminal belongs to. Then, the information is delivered to a second base station that the second terminal belongs to. As a last step of cellular communication, the second base station transmits the information to the second terminal. In this case, the first base station and the second base station may be the same base stations or may be different base stations.

If the first terminal and the second terminal are geographically adjacent to each other or a state of a channel between the two terminals is good, it is more effective to directly communicate between the two terminals rather than to communicate via the base station from the viewpoint of a time, frequency resource use efficiency, and a data transmission yield (achievable rate). The communication of directly transmitting and receiving at least one of the data and the control information between two terminals without via the base station in this way is referred to as direct communication between terminals. Also, the communication is simply referred to as D2D (Device-to-device) communication or D2D direct communication.

Further, hereinafter, when two terminals transmit or receive data or control to information directly, not via a base station, a data channel is referred to as a D-PUSCH (Physical Uplink Shared Channel), and a control channel between two terminals is referred to as a D-PUCCH. Also, a terminal transmitting the D-PUSCH is referred to as a D2D transmission terminal, and a terminal receiving a data channel is referred to as a D2D reception terminal.

Example embodiments of the present invention proposes a method by which terminals that generally communicate with a base station in a cellular mobile communication environment perform direct communication between the terminals according to a situation. Also, such communication between the two terminals may be switched to communication via a base station or to direct communication between two terminals not via a base station according to a situation. In this case, content of the direct communication between the terminals may be data information, control information, or both.

The following D2D communication scenarios may be considered.

(1) Only D2D communication between terminals belonging to the same cell is allowed.

(2) Only D2D communication between terminals belonging to the same base station is allowed when a base station manages several cells.

(3) D2D communication between any terminals is allowed regardless of a cell and a base station that the terminals belong to.

A duplexing scheme of an existing cellular mobile communication system may be divided into frequency division duplexing (FDD) and time division duplexing (TDD). In the case of the FDD scheme, a frequency band for transmission from a terminal to a base station (hereinafter referred to as an uplink band) differs from a frequency band for transmission from the base station the terminal (a downlink band).

On the other hand, in the TDD scheme, the frequency band for transmission from the terminal to the base station is the same as the frequency band for transmission from the base station the terminal. In the TDD scheme, a subframe used for transmission from the base station to the terminal is called a downlink subframe, and a subframe used for transmission from the terminal to the base station is called an up-link subframe.

In the case of the cellular FDD scheme, methods of applying D2D communication are as follows.

(1) Only an uplink band is used to perform the D2D communication.

(2) Only a downlink band is used to perform the D2D communication.

(3) Both the uplink band and the downlink band are used to perform the D2D communication.

In the case of the cellular TDD scheme, methods of applying the D2D communication are as follows.

(1) Only an uplink subframe is used to perform the D2D communication.

(2) Only a downlink subframe is used to perform the D2D communication.

(3) Both the uplink subframe and the downlink subframe are used to perform the D2D communication.

First, a case in which D2D communication is performed using the cellular FDD scheme will be considered. Above all, a method of applying D2D communication using only the uplink band will be described. Hereinafter, parts expressed as a “subframe” refer to a subframe used in the uplink band of a cellular FDD system.

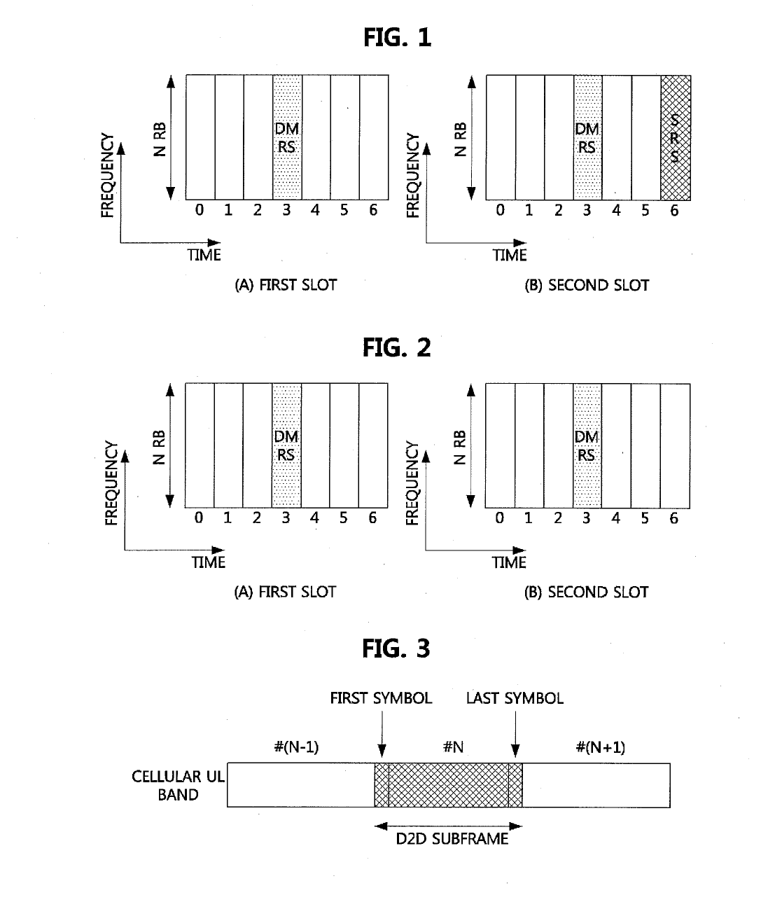

FIGS. 1 and 2 are diagrams illustrating subframe structures used for a terminal to transmit a data channel to a base station in cellular communication.

The subframe structures illustrated in FIGS. 1 and 2 correspond to a case of a normal CP (cyclic prefix). A terminal transmits a demodulation reference signal (DM-RS) in a third OFDM symbol (or a SC-FDMA symbol) section of a first slot and a third OFDM symbol (or a SC-FDMA symbol) section of a second slot of the subframe.

The base station sets subframes used for SRS transmission and reception in a relevant cell through a setting of cell-specific SRS (Sounding Reference Signal) subframe for each cell and notifies the terminals in the cell of the setting. According to LTE Release-10 standard (TS 36.211 Sec. 5.5), the cell-specific SRS subframes are represented by a period and an offset indicated in units of subframes. Further, the base station sets the terminal-specific SRS subframe for individual terminals, and the terminal transmits an SRS in the subframe corresponding to the setting. Information of setting of the terminal-specific SRS subframe includes information in which the subframes in which the terminal performs the SRS transmission are indicated by a period and an offset in units of subframes.

FIG. 1 illustrates a case in which the subframe corresponds to the cell-specific SRS subframe. The terminal transmits its own SRS in a last symbol section of the subframe or transmits nothing for SRS transmission of other terminals. Also, a physical uplink shared channel (hereinafter referred to as a PUSCH for convenience of description) is mapped to in symbol sections other than the symbols allocated for the DM-RS (Demodulation Reference Signal) and the SRS.

In other words, referring to FIG. 1, in a subframe having a normal CP (Cyclic Prefix) length, a DM-RS for demodulating the PUSCH may be transmitted in the third symbol of each slot, and the SRS may be transmitted in a sixth symbol of the second slot.

On the other hand, FIG. 2 illustrates a case in which the subframe is not specified as the cell-specific SRS subframe. The PUSCH is mapped to symbol sections other than the symbol allocated for the DM-RS.

Hereinafter, various technologies for direct communication between terminals will be described. The technologies described below may be applied alone to the direct communication between terminals and a combination of at least two technologies may be applied to the direct communication between terminals.

Transmission Time Point of Data/Control Information for Direct Communication Between Terminals

A base station (e.g., eNB) can perform signaling of TA (Timing Advance) information for D2D communication to a D2D transmission terminal. An example of a method of performing signaling of the TA information is use of MAC CE (Control Element). When any UE performs one-to-one (1:1) communication or one-to-many (1:several UEs) D2D communication with several UEs. The TA information for each D2D communication may be provided.

When the TA information for D2D communication is not provided from the base station (eNB), the D2D transmission terminal transmits D2D communication data or D2D communication control information according to its own uplink transmission timing. When the TA information for D2D communication is provided from the base station (eNB), the D2D transmission terminal transmits the D2D communication data or the D2D communication control information at a time advanced by the TA information from its own uplink transmission timing.

Now, the subframe structure for D2D communication proposed in Example embodiments of the present invention will be described. A physical shared channel between the D2D terminals is defined as a D-PUSCH.

Scheme of Modulating DM-RS and D-PUSCH for D-PUSCH Demodulation

A position in which the DM-RS (Demodulation RS) for D-PUSCH demodulation is transmitted is the same as a position in which a DM-RS for PUSCH demodulation is transmitted in cellular communication. In other words, when seven symbols are present in a time axis in one slot, a D2D transmission UE transmits the DM-RS for D-PUSCH demodulation in the third symbol section of each slot, as shown in FIGS. 1 and 2. When six symbols are present in a time axis in one slot, the DM-RS for D-PUSCH demodulation is transmitted in the second symbol section of each slot.

Modulation schemes for D-PUSCH may include an OFDMA scheme and an SC-FDMA scheme. In the SC-FDMA scheme, when a size of an IDFT (Inverse Discrete Fourier Transform) block or an IFFT (Inverse Fast Fourier Transform) block used in a transmission stage of the OFDMA scheme is N×N, a transmission signal passes through a DFT (or FFT) block having a size of M×M (M<N) before an IDFT (or IFFT) block is applied to the transmission signal.

First, a case in which a terminal applies the OFDMA scheme for the D-PUSCH will be described.

When any terminal transmits a PUSCH for cellular communication, the terminal applies the SC-FDMA scheme to generate a transmission signal. When the terminal transmits a D-PUSCH for D2D communication, the terminal applies the OFDMA scheme to generate a transmission signal.

When a D2D reception UE obtains CSI for a D2D link using at least one of the D-SRS and the DM-RS, the D2D reception UE obtains CSI information on the assumption that the OFDMA scheme is applied for D-PUSCH. Further, the D2D reception UE applies demodulation algorithms for OFDMA.

A case in which the terminal applies the SC-FDMA scheme for the D-PUSCH will be described.

Any terminal applies the SC-FDMA scheme to both the cellular communication and the D2D communication to generate a cellular PUSCH or a D-PUSCH for D2D communication.

When the D2D reception UE obtains CSI for a D2D link using at least one of the D-SRS and the DM-RS, the D2D reception UE obtains CSI information on the assumption that the SC-FDMA scheme is applied for the D-PUSCH. Further, the D2D reception UE applies a demodulation algorithm for SC-FDMA.

SRS for Channel State Information Measurement

The D2D terminals may transmit a D2D communication SRS (Sounding Reference Signal) in order to recognize and report channel state information (CSI) between two terminals that perform the D2D communication. This SRS is referred to as a D-SRS. The channel state information includes at least one of a PMI (Precoding matrix indicator), a RI (Rank indicator), and a CQI (Channel Quality Indicator).

The base station may perform signaling of information for D-SRS to the D2D communication terminals. The signaling information for D-SRS may include some or all of the following pieces of information.
D-SRS sequence group number
D-SRS base sequence number
D-SRS cyclic shift information
Number Nap of antenna ports used for D-SRS transmission
D-SRS transmission bandwidth srs-Bandwidth
Comb information (information indicating whether an odd subcarrier or even subcarrier is used)
Frequency hopping bandwidth information
Position of frequency for D-SRS transmission when frequency hopping is not used
D-SRS transmission period
D-SRS subframe offset

The D-SRS may be transmitted in a last symbol of a subframe. The D2D reception terminal recognizes channel state information (CSI) between two terminals using the D-SRS and reports related information to at least one of the base station and the D2D transmission terminal.

Method of Mapping Resources of D-PUSCH for Direct Communication Between Terminals

In the following description, it is assumed that a series of subframes include subframes for cellular communication and subframes for direct communication between terminals.

FIG. 3 is a conceptual diagram illustrating a structure of a series of subframes in direct communication between terminals according to an example embodiment of the present invention.

When any terminal performs both cellular communication and D2D communication in a cellular uplink band, the cellular communication and the D2D communication are separated from each other in terms of a time or a frequency.

Referring to FIG. 3, a case in which subframes up to subframe #(n−1) are used for cellular communication, subframe #n is used for direct communication between terminals, and subframes from subframe #(n+1) are used for the cellular communication again. In other words, this corresponds to a case in which any terminal uses subframe #n for D2D reception for an uplink band, in which D-PUSCH or control information for D2D communication is received in subframe #n.

Subframe #(n−1), subframe #n and subframe #(n+1) are assumed to be uplink subframes. In other words, a case in which a method using only the uplink band to perform the D2D communication among methods of applying the D2D communication to a cellular FDD scheme has been adopted is assumed.

In such an environment, when the terminal is assumed to transmit at least one of PUSCH, PUCCH, and SRS for cellular communication in subframe #(n−1), since the terminal performs transmission in subframe #(n−1) and must perform reception in subframe #n, a transition time for switching parts, elements or modules in the terminal from a transmission function to a reception function at a boundary between the two subframes is necessary.

Further, a signal sent by the D2D transmission terminal reaches the D2D reception terminal at a time different from an uplink transmission timing of the D2D reception terminal due to a “propagation delay” indicating a time taken for the signal sent by the D2D transmission terminal to reach the D2D reception terminal.

Accordingly, it may be difficult for the D2D reception terminal to receive the first symbol of subframe #n, which is the D2D subframe, due to the transition time for changing the parts in the terminal from the transmission function to the reception function and the propagation delay. It is more effective for the D2D transmission terminal not to transmit data or control information in the first symbol when it is difficult for the D2D reception terminal to receive the first symbol of the subframe.

Similarly, in the case of FIG. 3, when any terminal transmits a PUSCH or a PUCCH for cellular communication in subframe #(n+1) after using subframe #n for D2D reception for the uplink band, a transition time for switching parts in the terminal from a reception function to a transmission function at a boundary between subframe n and subframe (n+1) is necessary. Also, the transmission delay or the like must be considered. Therefore, in this case, it may be difficult for the D2D reception terminal to receive the last symbol of the D2D subframe. If it is difficult for the D2D reception terminal to receive the last symbol, it is more effective for the D2D transmission terminal not to transmit the data or the control information in the last symbol.

The following methods may be considered in order to solve or avoid a problem associated with transmission and reception of the first symbol and the last symbol of the subframe for D2D communication.

The following cases may be considered in order to determine whether the first symbol of subframe n has been transmitted or received when subframe n is used as the subframe for D2D communication. Hereinafter, for convenience of description, a first symbol of subframe k is indicated by Sk(0), a last symbol is indicated by Sk(E), and a second symbol from an end is indicated by Sk(E−1). Also, when a terminal performs cellular transmission in any given symbol, a state of the terminal is indicated by “C-Tx” (Cellular Transmit). When a terminal performs transmission of the D2D communication in a given symbol, a state of the terminal is indicated by “D-Tx” (D2D Transmit). When a terminal performs reception of the D2D communication in a given symbol, a state of the terminal is indicated by “D-Rx” (D2D Receive). When a terminal does not perform any of a transmission operation for cellular communication, a transmission operation for D2D communication, and a reception operation for D2D communication in any given symbol, a state of the terminal is indicated by “rest.”

In the following content, terminal 1 and terminal 2 are assumed to perform D2D communication. In this case, it is assumed that even when terminal 1 and terminal 2 belong to the same cell or belong to a different cell, cell-specific SRS subframes of two cells are set to be the same. Further, the term SRS collectively refers to a RS transmitted in the last symbol of the subframe, such as a SRS, a D-SRS and a PM-SRS for cellular communication.

First, a determination as to whether the first symbol in the D2D subframe has been transmitted or received, and related signaling will be described.

When subframe n is used for D2D communication, the following two cases (case 1 and case 2) are considered.

(Case 1) Subframe (n−1) is not a Cell-Specific SRS Subframe

Case 1 corresponds to a case in which terminal 1 and terminal 2 are assumed to perform D2D communication with each other in subframe n, and subframe (n−1) is not one of cell-specific SRS subframes of terminal 1 and terminal 2.

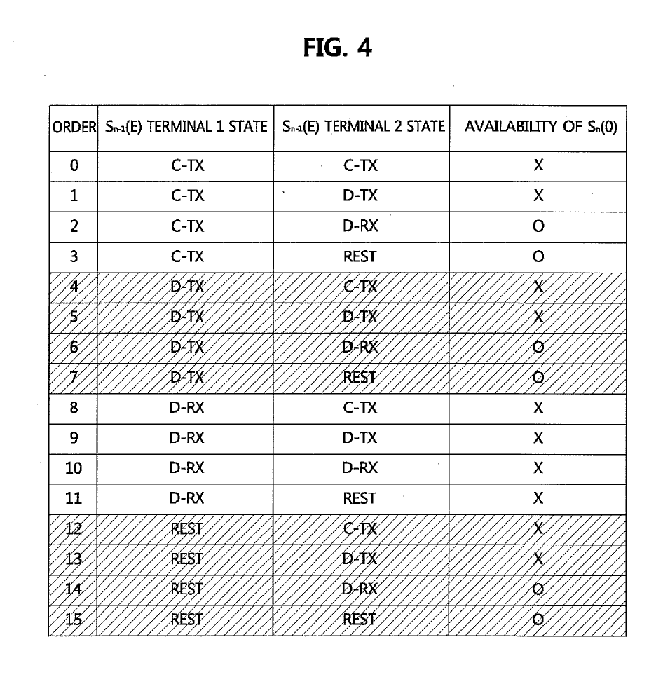

FIG. 4 is a table showing whether transmission/reception for the first symbol of the subframe for D2D communication is possible according to a state of a terminal.

In the table of FIG. 4, a first column indicates order attached when transmission/reception for the first symbol of the subframe for D2D communication is possible. A second column indicates a state for the last symbol Sₙ₋₁(E) of subframe (n−1) of terminal 1 performing D2D transmission in subframe n. A third column shows a state for the last symbol Sₙ₋₁(E) of subframe (n−1) of terminal 2 performing D2D reception in subframe n. In this case, a fourth column in the table of FIG. 4 shows whether the first symbol Sₙ(0) of subframe n is available for D2D communication.

In this case, even when the two terminals can transmit or receive the first symbol, signaling for instructing the terminals to perform transmission or reception of the symbol may be necessary. In the case, whether to transmit or receive the symbol or how to perform signaling will be described below.

A description of FIG. 4 is as follows. For example, row 0 indicates that terminal 1 (D2D transmission terminal) is in a C-Tx state in the last symbol of subframe (n−1) and terminal 2 (D2D reception terminal) is in a C-Tx state of the last symbol of subframe (n−1). In this case, this means that transmission and reception is impossible since the D2D transmission terminal can transmit the first symbol of subframe n, but the D2D reception terminal cannot receive the symbol. In this case, it is necessary for the D2D transmission terminal to apply rate matching for excluding resource elements RE present on the first symbol in D-PUSCH resource mapping or to transmit a D-PUCCH transmission format having a form that does not transmit the first symbol in consideration of the reception terminal not receiving the first symbol.

(Case 2) Subframe (n−1) is a Cell-Specific SRS Subframe

Case 2 corresponds to a case in which terminal 1 and terminal 2 are assumed to perform D2D communication with each other in subframe n and subframe (n−1) is one of cell-specific SRS subframes of the two terminals.

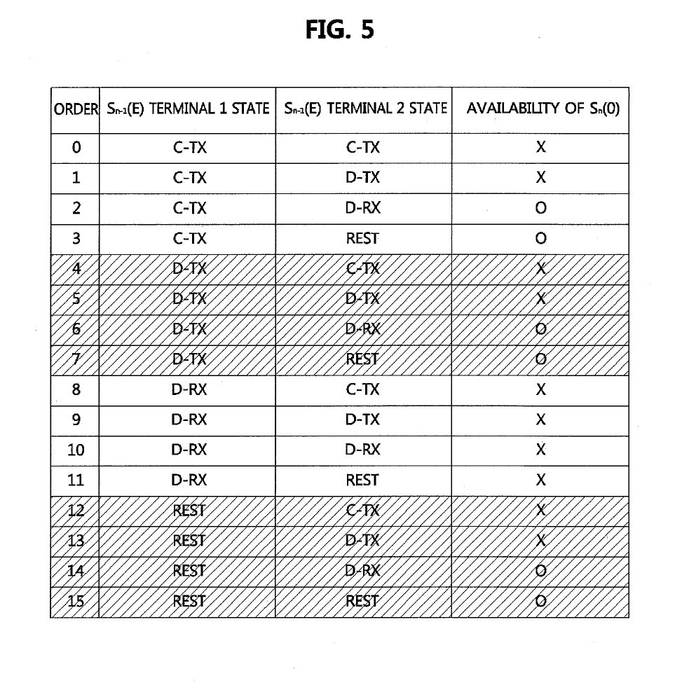

FIG. 5 is a table showing whether transmission/reception of the first symbol of the subframe for D2D communication is possible according to a state of terminal.

In the table of FIG. 5, a first column indicates order attached when transmission/reception for the first symbol of the subframe for D2D communication is possible. A second column indicates a state for the last symbol Sₙ₋₁(E) of subframe (n−1) of terminal 1 performing D2D transmission in subframe n. A third column shows a state for the last symbol Sₙ₋₁(E) of subframe (n−1) of terminal 2 performing D2D reception in subframe n. In this case, a fourth column in the table of FIG. 4 shows whether the first symbol Sₙ(0) of subframe n is available for D2D communication.

Next, a determination as to whether two last symbols in the D2D subframe has been transmitted or received, and related signaling will be described.

The following cases (Case 3 and Case 4) may be considered in order to determine whether two last symbols of subframe n have been transmitted or received when subframe n is used as the subframe for D2D communication.

(Case 3) Subframe n is not the Cell-Specific SRS Subframe

Case 3 corresponds to a case in which terminal 1 and terminal 2 are assumed to perform D2D communication with each other in subframe n, and subframe n is not one of cell-specific SRS subframes of terminal 1 and terminal 2

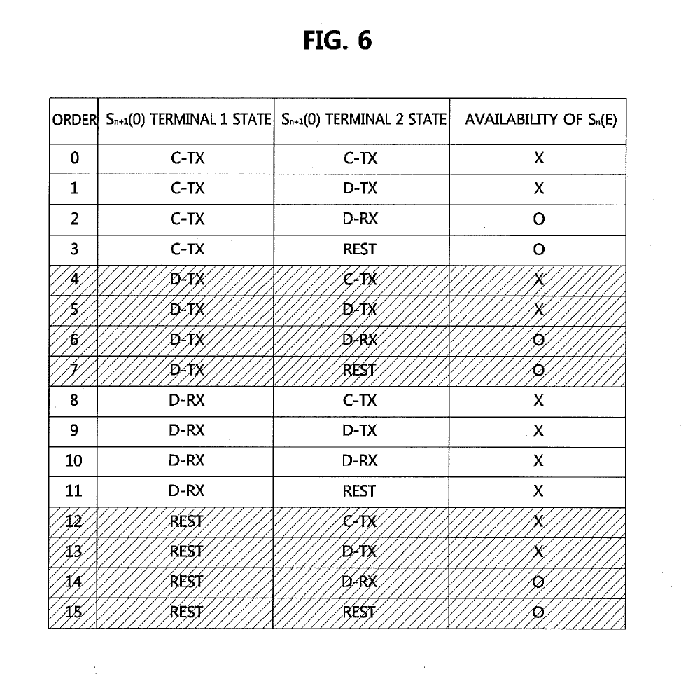

FIG. 6 is a table showing whether transmission/reception for the last symbol of the subframe for D2D communication is possible according to a state of a terminal.

In the table of FIG. 6, a first column indicates order attached when transmission/reception for the last symbol of the subframe for D2D communication is possible. A second column indicates a state for the first symbol Sₙ₊₁(0) of subframe (n+1) of terminal 1 performing D2D transmission in subframe n. A third column shows a state for the first symbol Sₙ₊₁(0) of subframe (n+1) of terminal 2 performing D2D reception in subframe n. In this case, a fourth column shows whether the last symbol Sₙ(E) of subframe n is available for D2D communication.

(Case 4) Subframe n is the Cell-Specific SRS Subframe

Case 4 corresponds to a case in which terminal 1 and terminal 2 are assumed to perform D2D communication with each other in subframe n, and subframe n is one of cell-specific SRS subframes of terminal 1 and terminal 2.

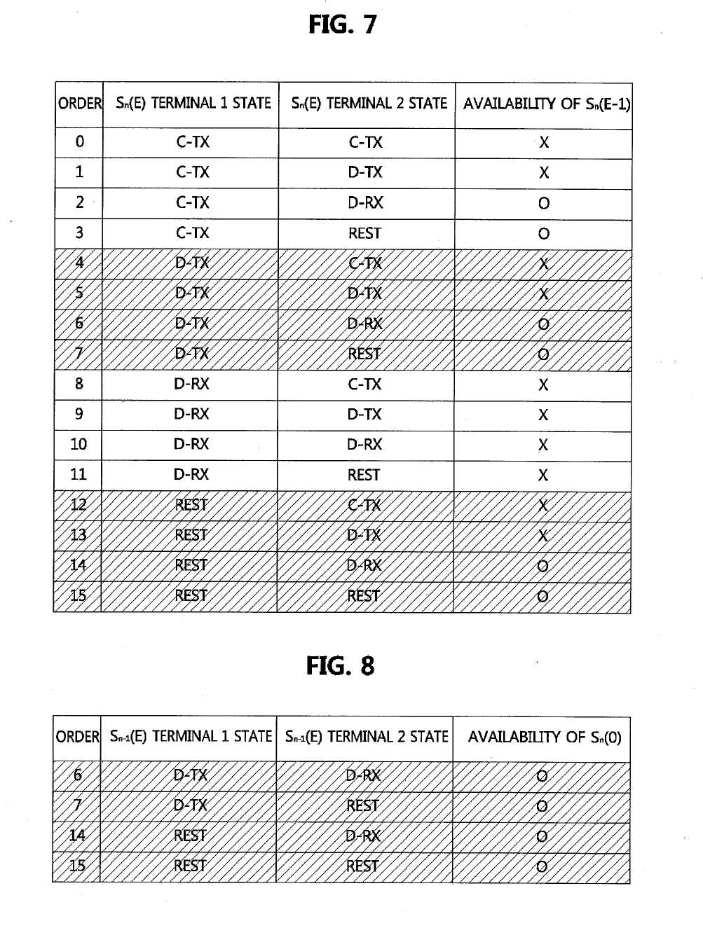

FIG. 7 is a table showing whether transmission/reception for the second symbol from an end of the subframe for D2D communication is possible according to a state of a terminal.

In the table of FIG. 7, a first column indicates order attached when transmission/reception for the second symbol from the end of the subframe for D2D communication is possible. A second column indicates a state for the last symbol Sₙ(E) of subframe n of terminal 1 performing D2D transmission in subframe n. A third column shows a state for the last symbol Sₙ(E) of subframe (n) of terminal 2 performing D2D reception in subframe n. A fourth column shows whether the second symbol Sₙ(E−1) from the end of subframe n is available for D2D communication.

Now, the following methods are proposed in conjunction with a determination as to whether the first symbol and the two last symbols of the D2D subframe have been transmitted and received as described above.

(Method 1) If a D2D communication terminal does not know a state of a partner terminal, a worst case is assumed and the D2D communication terminal does not always use the symbols for transmission and reception. In other words, it is necessary for the D2D communication terminal to apply rate matching for excluding resource elements RE present on the symbols in D-PUSCH resource mapping or to transmit a D-PUCCH transmission format having a form that does not transmit the symbols.

(Method 2) A base station determines whether relevant symbols have been transmitted or received in each transmission or reception and notifies two terminals of a determination result, and the two terminals perform transmission or reception accordingly. There is a disadvantage that a signaling overhead is generated, but there is an advantage that resources can be used without wasting.

In this case, a method by which the base station performs signaling to the two terminals may be a method of performing signaling using downlink control information (DCI). In this case, the number of additional bits necessary to represent whether the relevant symbols have been transmitted or received may be 1 or 2. Or, a method of mapping whether the relevant symbols have been transmitted or received according to another information field (Control Field) value of the DCI may be used instead of introducing the additional bits.

(Method 3) When the D2D terminals can know each other's state information for some cases through signaling of the base station, relevant symbols are used for transmission and reception. When the D2D terminals do not know each other's state information, a worst case is assumed and the relevant symbols are not always used for transmission and reception. The following is an example of cases in which the relevant symbols can be used for transmission and reception.

In the following cases, it is assumed that terminal 1 and terminal 2 perform D2D communication, and that terminal 1 performs transmission and terminal 2 performs reception in subframe n.

When each D2D terminal has known D2D transmission and reception subframes of the D2D terminal and the partner terminal through signaling of the base station in advance, and C-Tx has been set not to be generated, at least, in subframe (n+1), the D2D terminal knows a Sₙ₋₁(E) state of the partner terminal as well as the D2D terminal when subframe (n−1) is not the cell-specific SRS subframe. In other words, it can be seen that the D2D terminal is mapped to a D-Tx state if subframe (n−1) is a D2D transmission subframe, a D-Rx state if subframe (n−1) is a D2D reception subframe, and otherwise, a “rest” state.

FIG. 8 is a table showing states of a terminal in which the first symbol of the subframe for D2D communication is available.

In other words, when subframe (n−1) is not the cell-specific SRS subframe, Sₙ(0) may be used for D2D communication in four states shown in the table of FIG. 8.

When each D2D terminal has known D2D transmission and reception subframes of the D2D terminal and the partner terminal through signaling of the base station in advance, and C-Tx has been set not to be generated, at least, in subframe (n+1), the D2D terminal knows a Sₙ₊₁(0) state of the partner terminal as well as the D2D terminal when subframe n is not the cell-specific SRS subframe.

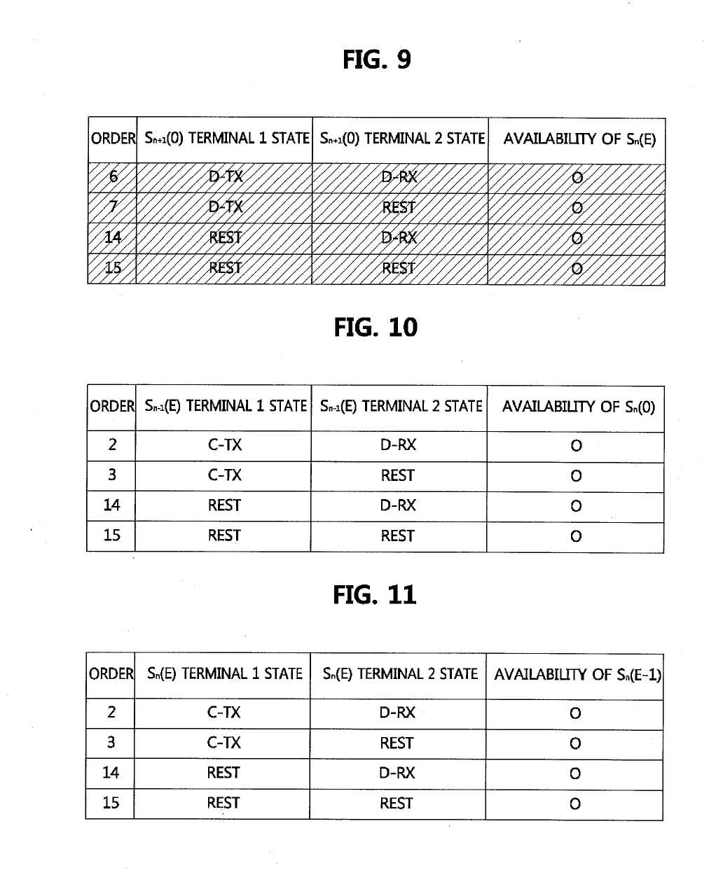

FIG. 9 is a table showing states of a terminal in which the last symbol of the subframe for D2D communication is available.

In other words, the terminal is mapped to a D-Tx state if subframe (n+1) is a D2D transmission subframe, a D-Rx state if subframe (n+1) is a D2D reception subframe, and otherwise, a rest state. Therefore, Sₙ(E) is available for D2D communication in four cases shown in the table of FIG. 9.

When each D2D terminal knows SRS transmission subframes and SRS reception subframes of the D2D terminal and the partner terminal through signaling of the base station in advance, the D2D terminal may know a state of the partner terminal as well as the D2D terminal for the last symbol Sₙ₋₁(E) of subframe (n−1) when subframe (n−1) is the cell-specific SRS subframe. In other words, it can be seen that the terminal is mapped to a C-Tx or D-Tx state if there is SRS transmission in the last symbol Sₙ₋₁(E) of the subframe (n−1), a D-Rx state if there is SRS reception, and otherwise, a rest state.

FIG. 10 is a table showing states of the terminal in which the first symbol of the subframe for D2D communication is available.

In other words, when subframe (n−1) is the cell-specific SRS subframe, Sₙ(0) is available for D2D communication in four cases shown in the table of FIG. 10.

When each D2D terminal knows SRS transmission subframes and SRS reception subframes of the D2D terminal and the partner terminal through signaling of the base station in advance, the D2D terminal may know a state of the partner terminal as well as the D2D terminal for the last symbol Sₙ(E) of subframe n when subframe n is the cell-specific SRS subframe.

FIG. 11 is a table showing states of the terminal in which the last symbol of the subframe for D2D communication is available.

In other words, the terminal is mapped to a C-Tx or D-Tx state if there is SRS transmission in the last symbol Sₙ(E) of the subframe n, to a D-Rx state if there is SRS reception, and otherwise, to a rest state. Therefore, Sₙ(E−1) is available for D2D communication in four cases shown in the table of FIG. 11.

When D2D terminals do not know each other's state information, a worst case is assumed and relevant symbols are not always used for transmission and reception.

Here, it is noted that when any subframe is a terminal-specific SRS transmission subframe of any terminal, the last symbol of the subframe is regarded as being always in the C-Tx or D-Tx state. This is because, even when SRS transmission for terminal identification may drop due to a collision with CSI feedback, the relevant symbol is used for transmission such as CSI feedback and accordingly must be regarded as being in the Tx state.

When terminal 1 and 2 perform D2D communication, the base station may notify terminal 1 of the UE-specific SRS subframe position information for terminal 2, PM-SRS transmission and reception subframe information, CSI-SRS transmission and reception subframe information and the like. Similarly, the base station may notify terminal 2 of UE-specific SRS subframe position information for terminal 1, PM-SRS transmission and reception subframe information, CSI-SRS transmission and reception subframe information and the like.

Using this information, terminals 1 and 2 may determine whether the first symbol and two last symbols in the subframe for D-PUSCH transmission/reception are to be used or not for D-PUSCH transmission.

Method of Measuring and Reporting a Proximity Degree Between Terminals

D2D terminals participating in D2D communication may transmit a signal for measurement of a proximity degree in order to measure a proximity degree between the two terminals. Also, the D2D terminal may receive the signal for proximity degree measurement transmitted by the partner D2D terminal to measure the proximity degree between the two terminals. The signal used for the proximity degree measurement in this way is referred to as a PM-SRS (proximity measurement sounding reference signal).

The PM-SRS is transmitted in a last symbol position of the subframe, and the base station performs signaling of configuration information related to the PM-SRS to the two terminals. The signaling method may be RRC signaling.

Pieces of signaling information for the PM-SRS may include the following pieces of information.
PM-SRS sequence group number
PM-SRS-base sequence number
PM-SRS cyclic shift information
Number Nap of antenna ports used for PM-SRS transmission
PM-SRS transmission bandwidth srs-Bandwidth
Comb information (information indicating whether an odd subcarrier or an even subcarrier is used)
Frequency hopping bandwidth information
Position of frequency for PM-SRS transmission when frequency hopping is not used
PM-SRS transmission period
PM-SRS subframe offset

The D2D terminal may receive the PM-SRS transmitted by the partner D2D terminal and estimate reception synchronization.

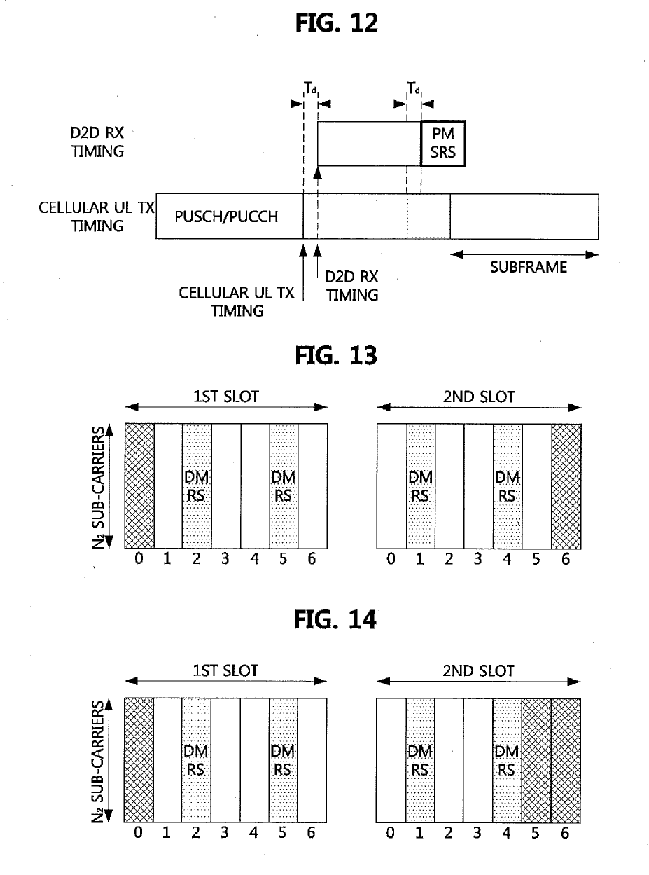

FIG. 12 is a conceptual diagram illustrating a concept of D2D reception synchronization estimation using a PM-SRS.

Referring to FIG. 12, when a difference between a timing for cellular uplink transmission of the terminal and a reception timing for the D2D subframe is Td, Td is estimated using the PM-SRS. Further, at least one of signal strength D2D-RSRP (D2D Reference Signal Received Power; D2D-RSRP) and D2D-RSRQ (D2D-Reference Signal Received Quality) corresponding to SIR information of the signal is measured using the PM-SRS. D2D-RSRP or D2D-RSRQ may be measured using one PM-SRS or may be measured using several PM-SRS for a long period of time.

Further, the D2D terminal reports at least one of the base station and the D2D transmission terminal of at least one of D2D-RSRP and D2D-RSRQ. The base station may perform signaling of a report period for a D2D-RSRP and D2D-RSRQ measurement report to the partner D2D terminal.

The base station or the terminal having received the report may estimate the proximity degree between two terminals using at least one information of D2D-RSRP and D2D-RSRQ. Further, using this information, a determination may be made whether the communication between the two terminals is to be switched from the cellular communication to the D2D communication or a determination may be made as to whether D2D communication is to be continuously maintained or switching to the cellular communication is to be performed when the two terminals are already performing the D2D communication.

Interference Measurement Method for Direct Communication Between Terminals

In the case of D-PUSCH reception, when adjacent terminals perform cellular communication PUSCH or D-PUSCH transmission using the same resources, very great interference may be generated.

For Interference between adjacent cells in the same base station, the base station may perform resource allocation for interference avoidance. In other words, terminals that may interfere with each other may use different resources according to a degree of the interference to avoid the interference or appropriate power control may be performed using the same resources.

For interference management, the base station needs the following information.
Measurement result for serving/adjacent transmission point of the terminal
Measurement result for a D2D link of the terminal
Measurement result for another D2D link/cellular link

The base station may perform signaling of a CSI RS (Channel State Information Reference Signal) corresponding to the transmission points to the terminal in order to obtain the measurement result for the serving/adjacent transmission point of the terminal, and request a measurement result thereto. The base station may perform signaling of configuration information of the RS (Reference Signal) of a relevant link to the terminal in order to obtain the measurement result for the D2D link of the terminal and the measurement result for another D2D link/cellular link, and request a measurement result for the RS. The RS configuration information may be SRS configuration information, DM RS configuration information, PM-SRS configuration information or the like.

One form of the measurement result is RSRP and RSRQ. Hereinafter, RSRP and RSRQ are referred to as D-RSRP and D-RSRQ for convenience of description. D-RSRP is measured using at least one of the SRS configuration information, the PM-SRS configuration information, and the DM-RS configuration information.

The terminal performs the requested measurement and reports the measurement result to the base station. When an influence of the interference on the D2D link of the terminal is measured, it is desirable to measure the interference according to a D2D link reception timing of the terminal.

D-RSRQ has a format of a value obtained by dividing D-RSRP by D-RSSI (D2D Received Signal Strength Indicator). In this case, the base station may notify the D2D reception terminal of a position of the subframe to be used to obtain D-RSSI through RRC signaling. In this case, it is necessary for the D2D reception terminal to measure D-RSSI in positions of all subframes received through signaling. When D-RSSI is measured in the subframe, D-RSSI for all symbols may be measured or D-RSSI may be measured in symbols other than at least one of the first symbol, the last symbol and the last symbol.

Another form of the measurement result is a reception timing. The terminal may estimate a reception timing from RS (SRS or DM RS) which is a measurement target and report a difference between a cellular uplink transmission timing (or a cellular downlink reception timing) and a reception timing to the base station or the partner D2D terminal The difference between the timings indicates Td in FIG. 4.

Simultaneous Scheduling Issue in Direct Communication Between Terminals and Cellular Communication

When any terminal is granted to perform D2D data (or control information) transmission and cellular uplink transmission of the same subframe to the D2D partner terminal during D2D communication, the D2D terminal may perform the following operation on the subframe.

(Method 1) The D2D terminal performs only the cellular uplink transmission to the base station and does not transmit data (or control information) for D2D communication.

(Method 2) The D2D terminal transmits only data (or control information) for D2D communication and does not transmit data (or control information) for cellular uplink transmission.

(Method 3) The D2D terminal simultaneously transmits data (or control information) to be transmitted to the D2D partner terminal and data (or control information) to be transmitted to the base station.

(Method 4) The D2D terminal transmits, to the base station, both data (or control information) to be transmitted to the D2D partner terminal and data (or control information) to be transmitted through a cellular uplink. In this case, the data is transmitted using a cellular uplink shared channel (PUSCH) or a cellular uplink control channel (PUCCH).

D-PUCCH Design for Direct Communication Between Terminals

The D2D reception terminal may transmit control information related to D2D communication to at least one of the base station and the D2D transmission terminal. In this case, the control information related to D2D communication may include at least one from information of ACK/NACK (hereinafter simply referred to as A/N) for the D-PUSCH and CSI information of the D2D link. When such control information is transmitted to the D2D transmission terminal, a physical layer channel carrying this information is referred to as D-PUCCH.

FIG. 13 is a conceptual diagram illustrating an example of a design of a D-PUCCH having a normal format.

FIG. 13 is a conceptual diagram illustrating a position in which D-PUCCH having a normal format is transmitted in a subframe having a normal CP (Cyclic Prefix), and illustrates two slots constituting one subframe (hereinafter, the same applies to FIGS. 14 to 25).

In a first slot, a DM-RS is transmitted in second and fifth symbols. In a second slot, a DM-RS is transmitted in first and fourth symbols. A D-PUCCH is not transmitted in a 0^{th} symbol of the first slot and a last symbol (a sixth symbol) of the second slot. The D-PUCCH is transmitted in symbols other than the symbols in which the DM-RS is transmitted, the 0^{th} symbol of the first slot and the last symbol (the sixth symbol) of the second slot in the subframe (the two slots). A bandwidth in which the D-PUCCH is transmitted includes N2 subcarriers. A position of a frequency in which the D-PUCCH is transmitted may differ between the first slot and the second slot.

FIG. 14 is a conceptual diagram illustrating an example of a design of a D-PUCCH having a shortened format.

FIG. 14 is a conceptual diagram illustrating a shortened format for a D-PUCCH in a subframe having normal CP. The D-PUCCH in this case is transmitted in symbols other than symbols in which the DM-RS is transmitted, a 0^{th} symbol of a first slot and two last symbols of a second slot in the subframe. A position of a frequency in which the D-PUCCH is transmitted may differ between the first slot and the second slot. A bandwidth in which the D-PUCCH is transmitted includes N2 subcarriers.

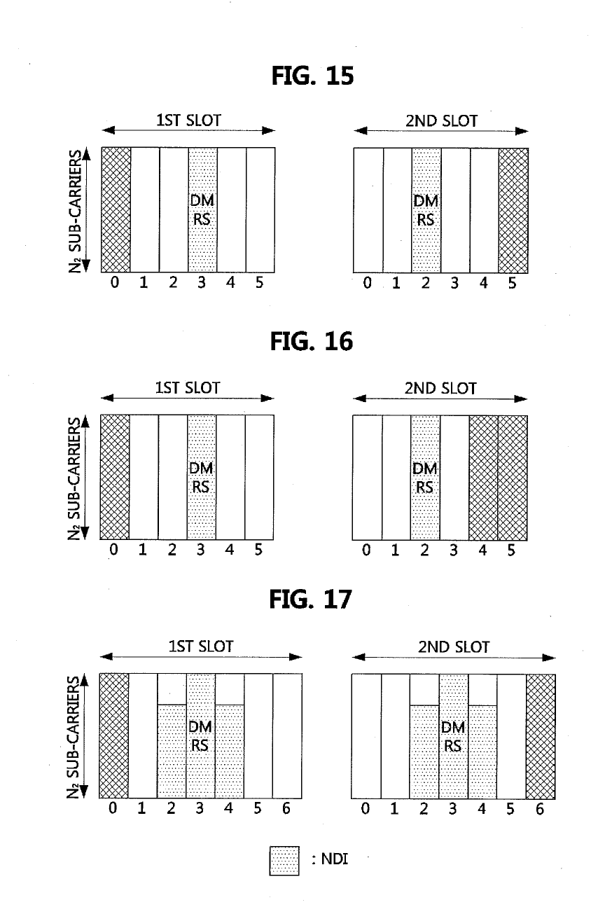

FIG. 15 is a conceptual diagram illustrating another example of the design of a D-PUCCH having a normal format.

FIG. 15 is a conceptual diagram illustrating a DM-RS transmission position and a transmission position of a D-PUCCH having a normal format in a subframe having an extended CP. A DM-RS is transmitted in a third symbol of a first slot and a second symbol of a second slot. The D-PUCCH is transmitted in symbols other than symbols in which the DM-RS is transmitted, a 0^{th} symbol of the first slot and a last symbol of the second slot in the subframe. A position of a frequency in which the D-PUCCH is transmitted may differ between the first slot and the second slot. A bandwidth in which the D-PUCCH is transmitted includes N2 subcarriers.

FIG. 16 is a conceptual diagram illustrating another example of the design of a D-PUCCH having a shortened format.

FIG. 16 is a conceptual diagram illustrating a DM-RS transmission position and a transmission position of a D-PUCCH having a shortened format in a subframe having an extended CP. A DM-RS is transmitted in a third symbol of a first slot and a second symbol of a second slot. The D-PUCCH is transmitted in symbols other than symbols in which the DM-RS is transmitted, a 0^{th} symbol of the first slot and two last symbols of the second slot in the subframe. A position of a frequency in which the D-PUCCH is transmitted may differ between the first slot and the second slot. A bandwidth in which the D-PUCCH is transmitted includes N2 subcarriers.

(Method of Transmitting NDI and ACK/NACK)

In LTE-based cellular communication, a new data indicator (NDI) for a downlink data channel (PDSCH) or an uplink data channel (PUSCH) is transmitted in downlink control information (DCI). In this case, the DCI information is transmitted to a terminal through a downlink control channel (PDCCH). A base station notifies the terminal that data transmitted through the channel is new data or a retransmission of previous data through NDI information.

Methods of performing direct communication between terminals may include several methods according to a participation degree of the base station. A method by which a transmission terminal determines an initial transmission and a retransmission for data will be described. For this, a case in which a reception terminal transmits an indication (ACK or NACK) showing that decoding for D-PUSCH is successfully performed, to only the transmission terminal or transmits the indication showing that decoding is successfully performed, to both the base station and the transmission terminal. The transmission terminal may determine the initial transmission and the retransmission for data using the ACK/NACK (hereinafter simply referred to as A/N) information fed back by the reception terminal. Also, the transmission terminal must notify the reception terminal that the data transmitted by the D-PUSCH is the initial transmission or the retransmission. For this, a method of transmitting an NDI together with the D-PUSCH is used.

FIG. 17 is a conceptual diagram illustrating a transmission position of the NDI.

FIG. 17 is a conceptual diagram illustrating a method of transmitting the NDI together with the D-PUSCH when a length of the cyclic prefix (CP) is normal (a normal CP case). A case in which a DM-RS for demodulating the D-PUSCH is transmitted in third symbols of a first slot and a second slot and the NDI is transmitted in second and fourth symbols of each slot is considered. In this case, when the number of transport blocks (TB) transmitted by the D-PUSCH is 1, the NDI is 1-bit information, and when the number of the TBs is 2, the NDI is 2-bit information.

Now, the following case is considered. A case in which terminal 1 and terminal 2 perform D2D communication and terminal 1 transmits D-PUSCH and A/N to terminal 2 will be described. In this case, A/N is A/N information for the D-PUSCH that terminal 2 has transmitted to terminal 1. In this case, it is necessary for terminal 1 to transmit D-PUSCH, NDI, and A/N information to terminal 2. In this case, a case in which all the pieces of information are sent on the D-PUSCH will be described.

There may be two methods of encoding NDI and A/N. In other words, one method is a method of performing separate coding on NDI and A/N, and the other method is a method of performing joint coding on NDI and A/N. A method of mapping A/N resources in each case will be described.

First, the method of mapping A/N resources when. NDI and A/N are separately coded is as follows.

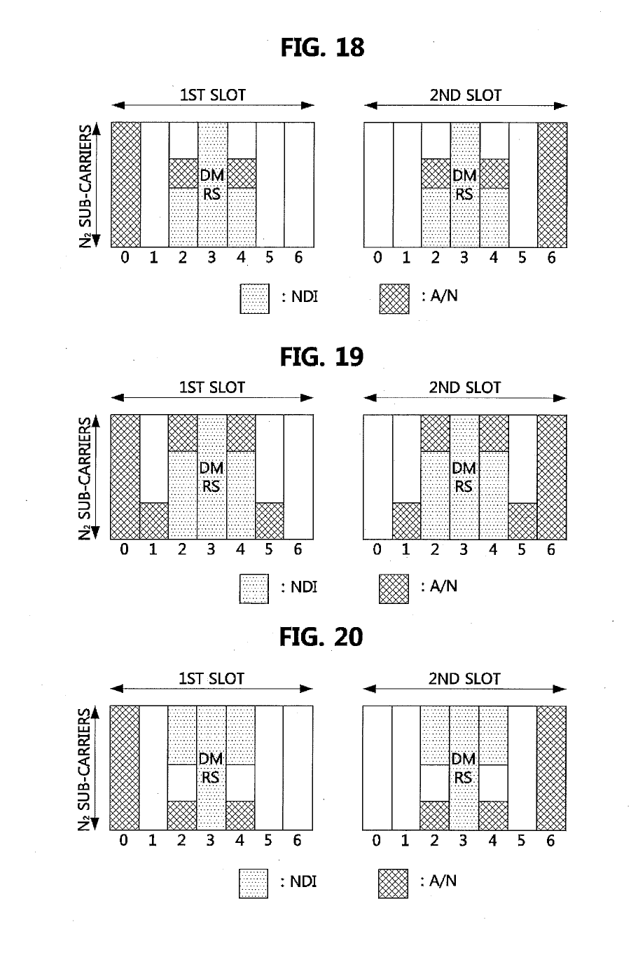

(Method 1) A method of mapping NDI sequentially from one edge frequency position in positions of second and fourth symbols of each slot in resources allocated for D-PUSCH transmission and then mapping A/N. FIG. 18 is a conceptual diagram illustrating an application example of NDI and A/N mapping method 1.

In this case, when the number of subcarriers allocated to transmit a D-PUSCH is N2 and the number of resources necessary for NDI and A/N transmission is more than the number N2 of the subcarriers, additional mapping to a first symbol and a fifth symbol of each slot may be performed. FIG. 19 is a conceptual diagram illustrating another application example of NDI and A/N mapping method 1 and illustrates an application example of A/N mapping method 1 when the number of resources necessary for A/N transmission is more than the number N2 of the subcarriers.

(Method 2) A method of mapping NDI sequentially from one edge frequency position in positions of second and fourth symbols of each slot in resources allocated for D-PUSCH transmission and mapping A/N sequentially from the other edge frequency position. FIG. 20 is a conceptual diagram illustrating an application example of NDI and A/N mapping method 2.

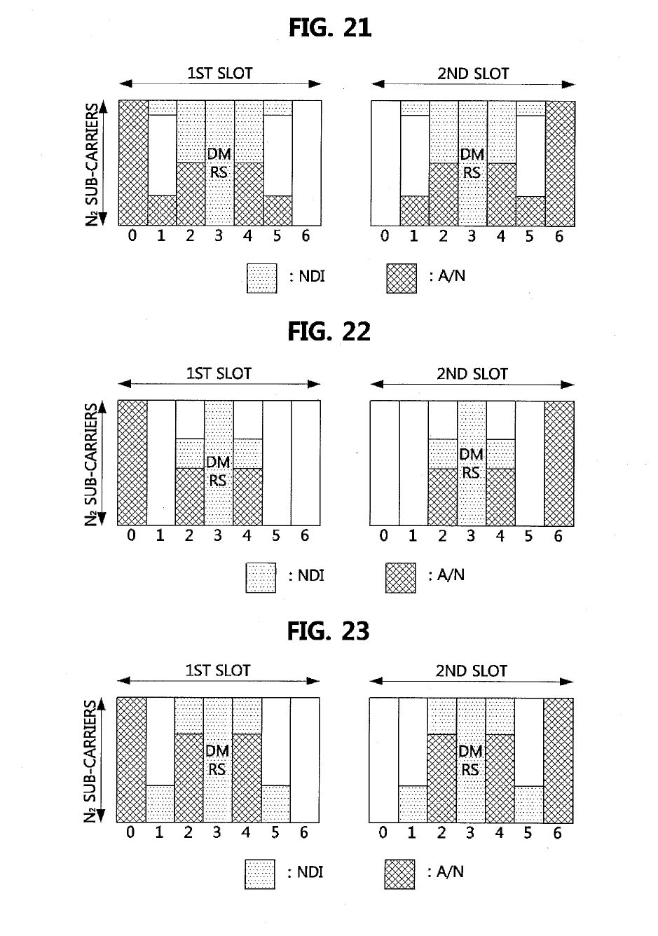

In this case, when the number of resources necessary for NDI and A/N transmission is more than the number N2 of the subcarriers, additional mapping to a first symbol and a fifth symbol of each slot may be performed. FIG. 21 is a conceptual diagram illustrating another application example of NDI and A/N mapping method 2 and illustrates an application example of A/N mapping method 2 when the number of resources necessary for NDI and A/N transmission is more than the number N2 of the subcarriers.

(Method 3) A method of mapping A/N sequentially from one edge frequency position in positions of second and fourth symbols of each slot in resources allocated for D-PUSCH transmission and then mapping NDI. FIG. 22 is a conceptual diagram illustrating an application example of NDI and A/N mapping method 3.

In this case, when the number of subcarriers allocated to transmit a D-PUSCH is N2 and the number of resources necessary for NDI and A/N transmission is more than the number N2 of the subcarriers, additional mapping to a first symbol and a fifth symbol of each slot may be performed. FIG. 23 is a conceptual diagram illustrating another application example of NDI and A/N mapping method 3 and illustrates an application example of A/N mapping method 3 when the number of resources necessary for NDI and A/N transmission is more than the number N2 of the subcarriers.

The D-PUSCH is mapped to a position of resources other than resources used for DM-RS, NDI, and A/N. In this case, the D-PUSCH may be mapped to all symbol positions in the subframe in resources other than the resources used for DM-RS, NDI, and A/N or may be mapped to a position of a symbol other than at least one of the first symbol, the last symbol and the second symbol from an end in the subframe.

Next, an A/N resource mapping method when NDI and ACK/NACK are coded together is as follows.

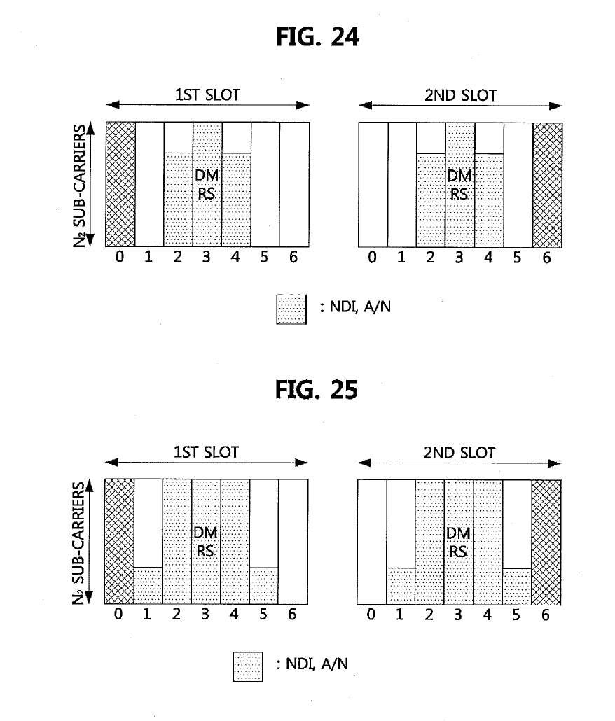

FIG. 24 is a conceptual diagram illustrating an application example of NDI and A/N mapping method 4.

As illustrated in FIG. 24, a signal as a result of joint coding of NDI and A/N may be mapped sequentially from one edge frequency position in the positions of the second symbol and the fourth symbol of each slot in the resources allocated for D-PUSCH transmission. In this case, when the number of subcarriers allocated to transmit a D-PUSCH is N2 and the number of resources necessary for NDI and A/N transmission is more than the number N2 of the subcarriers, additional mapping to a first symbol and a fifth symbol of each slot may be performed. FIG. 25 is a conceptual diagram illustrating another application example of NDI and A/N mapping method 4 and illustrates an application example of A/N mapping method 4 when the number of resources necessary for NDI and A/N transmission is more than the number N2 of the subcarriers.

The D-PUSCH is mapped to a position of resources other than resources used for DM-RS, NDI, and A/N. In this case, the D-PUSCH may be mapped to all symbol positions in the subframe in resources other than the resources used for DM-RS, NDI, and A/N or may be mapped to a position of a symbol other than at least one of the first symbol, the last symbol and the second symbol from an end in the subframe.

While the example embodiments of the present invention and their advantages have been described in detail, it should be understood that various changes, substitutions and alterations may be made herein without departing from the scope of the invention.

What is claimed is:

1. A method of operating a terminal that receives data or control information from a partner terminal through direct communication between terminals using a subframe for D2D communication among subframes, the subframes being classified into a subframe for cellular communication and the subframe for D2D communication, a D2D communication method comprising:
receiving state information of the partner terminal from a base station; and
determining whether the data or the control information is received from the partner terminal in at least some symbols of the subframe for D2D communication based on the state information.

2. The D2D communication method according to claim 1, wherein the subframe for D2D communication is arranged before or after the subframe for cellular communication.

3. The D2D communication method according to claim 2, wherein: when the subframe for D2D communication is arranged after the subframe for cellular communication, the data or control information is not received from the partner terminal in at least some front symbols of the subframe for D2D communication.

4. The D2D communication method according to claim 2, wherein: when the subframe for D2D communication is arranged before the subframe for cellular communication, the data or control information is not received from the partner terminal in at least some rear symbols of the subframe for D2D communication.

5. The D2D communication method according to claim 1, wherein the state information of the partner terminal includes at least some of UE-specific SRS subframe position information, PM-SRS transmission and reception subframe information, and CSI-SRS transmission and the reception subframe information.

6. A method of operating a terminal that receives data or control information from a partner terminal through direct communication between terminals using a subframe for D2D communication among subframes, the subframes being classified into a subframe for cellular communication and the subframe for D2D communication, a D2D to communication method comprising:
receiving information indicating whether at least some symbols of the subframe for D2D communication are used from a base station; and
determining whether the data or the control information is received from the partner terminal in at least some symbols of the subframe for D2D communication based on the information indicating whether at least some symbols of the subframe for D2D communication are used.

7. The D2D communication method according to claim 6, wherein the subframe for D2D communication is arranged before or after the subframe for cellular communication.

8. The D2D communication method according to claim 7, wherein: when the subframe for D2D communication is arranged after the subframe for cellular communication, the data or control information is not received from the partner terminal in at least some front symbols of the subframe for D2D communication.

9. The D2D communication method according to claim 7, wherein: when the subframe for D2D communication is arranged before the subframe for cellular communication, the data or control information is not received from the partner terminal in at least some rear symbols of the subframe for D2D communication.

10. The D2D communication method according to claim 7, wherein the information indicating whether at least some symbols of the subframe for D2D communication are used is received as downlink control information (DCI) from the base station, and includes 1 or 2 bits.

11. A method of transmitting control information in a terminal performing device-to-device communication, the method comprising:
mapping a DM-RS (Demodulation RS) to subframe resources in which device-to-device communication (D2D) data is transmitted;
mapping the control information to the subframe resources;
mapping the device-to-device communication data to resources other than the resources to which the DM-RS and the control information are mapped among the subframe resources; and
transmitting the subframe to a partner terminal of device-to-device communication.

12. The method according to claim 11, wherein the control information is preferentially mapped to a symbol adjacent to a symbol to which the DM-RS is mapped in the subframe resources.

13. The method according to claim 11, wherein the control information is not mapped to a first symbol of a first slot of the subframe resources and a last symbol of a second slot of the subframe resources.

14. The method according to claim 11, wherein the control information includes at least one of new data indicator (NDI) information and ACK/NACK information.

15. The method according to claim 14, wherein the new data indicator and the ACK/NACK information are subjected to separate coding or joint coding and mapped to the subframe resources.

16. The method according to claim 15, wherein: when the new data indicator and the ACK/NACK information are subjected to separate coding, at least one of the new data indicator and the ACK/NACK information is mapped from an edge frequency band in the subframe resources.

17. The method according to claim 15, wherein: when the new data indicator and the ACK/NACK information are subjected to joint coding, the control information is mapped from an edge frequency band in the subframe resources.

18. The method according to claim 11, wherein the device-to-device communication data is not mapped to a first symbol of a first slot of the subframe resources and a last symbol of a second slot of the subframe resources.
